(19) United States
(12) Patent Application Publication
(10) Pub. No.: US 2008/0240732 A1
(43) Pub. Date: Oct. 2, 2008

(54) OPTICAL COMMUNICATION MODULE AND CONTROL METHOD THEREOF

(76) Inventors: Chien-Shu Chiu, Taoyuan Hsien (TW); Yung-Yuan Cheng, Taoyuan Hsien (TW); Chiung-Hung Wang, Taoyuan Hsien (TW)

Correspondence Address: BIRCH STEWART KOLASCH & BIRCH, PO BOX 747, FALLS CHURCH, VA, 22040-0747, US

(21) Appl. No.: 12/027,108

(22) Filed: Feb. 6, 2008

(30) Foreign Application Priority Data
Mar. 30, 2007 (TW) 096111214

(51) Int. Cl. H04B 10/04

(52) U.S. Cl. 398/183

(57) ABSTRACT

An optical communication module includes a driving unit, an optical transmitting unit, a control unit and a signal transform control unit. The driving unit outputs a bias signal and a modulation signal in accordance with a bias control signal and a modulation control signal. The optical transmitting unit is electrically connected to the driving unit, outputs an optical signal in accordance with the bias signal and the modulation signal, and generates a feedback signal. The signal transform control unit is electrically connected to the driving unit and generates the bias control signal and the modulation control signal to be inputted to the driving unit. The control unit is electrically connected to the optical transmitting unit and the signal transform control unit, and controls the signal transform control unit in accordance with the feedback signal. A control method of the optical communication module is also disclosed.

### CROSS REFERENCE TO RELATED APPLICATIONS

This Non-provisional application claims priority under 35 U.S.C. §119(a) on Patent Application No(s). 096111214 filed in Taiwan, Republic of China on Mar. 30, 2007, the entire contents of which are hereby incorporated by reference.

### BACKGROUND OF THE INVENTION

1. Field of Invention

The invention relates to a communication module and a control method thereof, and more particularly to an optical communication module and a control method thereof.

2. Related Art

The fiber communication technique has been developed since 1960. At early stages, the intensity of the optical signal decays to 1% after traveling through 20 meters. Nowadays, the intensity of the optical signal only decays 1 dB per one kilometer. In addition, the optical fiber cable with the bandwidth larger than 800 MHz can be mass produced, and the high order digital multiplex technique and the opto-electronic device with high performance have been developed. Therefore, the optical communication system with high capacity and high speed (such as having the transmission rate faster than 1.25 Gbps even 10 Gbps) has been achieved.

In a conventional optical communication system, the light source is usually a light emitting diode (LED) or a laser diode (LD). The LED and LD are both semiconductor elements having the characteristics of small size, good reliability and optimum wavelength. In addition, the semiconductor element can be modulated under high frequency operation, so that it is suitable for the optical communication system. Because the LED has poor lighting efficiency (only 1% of input power can be transformed to light about 100 uW) and wider lighting spectrum, which leads to more light dispersion, it is usually applied to local area network with the transmission speed of 10 to 100 Mbps and transmission distance of several kilometers. Compared with the LED, the LD with the output power of 100 mW has narrower lighting spectrum, thereby having better transmission speed and transmission distance.

FIG. 1 is a schematic diagram of a conventional optical communication module 10. The optical communication module 10 includes an optical transmitting unit 11, a driving unit 12, a digital resistor unit 13, a comparing unit 14, a thermoelectric cooler (TEC) unit 15 and a modulator voltage source 16.

The optical transmitting unit 11 has an optical diode 111, a laser diode 112, a modulation diode 113 and a thermoelectric cooler 114.

The driving unit 12 generates a bias signal for driving the laser diode 112 in accordance with a bias control signal, and generates a modulation signal in accordance with a modulation control signal.

The modulator voltage source 16 generates a constant voltage. The constant voltage is mixed with the modulation signal to form a modulator DC bias signal for controlling the modulation diode 113 and regulating an output power of the laser diode 112.

The digital resistor unit 13 has a digital bias resistor 131 and a digital modulation resistor 132. The digital bias resistor 131 generates a reference voltage, which is inputted into the comparing unit 14. The digital modulation resistor 132 generates the modulation control signal, which is inputted into the driving unit 12.

As mentioned above, the optical diode 111 of the optical transmitting unit 11 generates a relative current when the optical power outputted by the laser diode 112 is sensed. The relative current is transformed into an optical voltage signal, which is inputted into the comparing unit 14, through a resistor R01. The comparing unit 14 generates the bias control signal, which is inputted into the driving unit 12, after comparing the optical voltage signal with the reference voltage. The thermoelectric cooler unit 15 controls the thermoelectric cooler 114 for controlling the temperature.

The conventional optical communication module 1 utilizes the digital resistor unit 13 as the control parameter for controlling the optical transmitting unit 11. However, the characteristic of each optical transmitting unit are different so that each of the optical transmitting units must regulate the relative resistance of the digital resistor for compensating the relative bias signal and the relative modulation signal of the optical transmitting unit 11 operating at different temperatures. In the procedure, the resistance of each digital resistor must be regulated under different temperatures for recording the relative voltage output. Accordingly, the manufacturing time will be increased due to the regulating process, and the manufacturing procedure will be also become more complex.

Therefore, there is a need to decrease the regulating time for the resistance of the digital resistor so as to simplify the manufacturing procedure of the optical communication module.

### SUMMARY OF THE INVENTION

In view of the foregoing, an object of the invention is to provide an optical communication module and a control method thereof, which can perform feedback control without the conventional regulating process.

To achieve the above, the invention discloses an optical communication module including a driving unit, an optical transmitting unit, a control unit and a signal transform control unit. The driving unit outputs a bias signal and a modulation signal in accordance with a bias control signal and a modulation control signal. The optical transmitting unit is electrically connected to the driving unit, outputs an optical signal in accordance with the bias signal and the modulation signal, and generates a feedback signal. The signal transform control unit is electrically connected to the driving unit and generates the bias control signal and the modulation control signal, which are input to the driving unit. The control unit is electrically connected to the optical transmitting unit and the signal transform control unit, and controls the signal transform control unit in accordance with the feedback signal.

To achieve the above, the invention also discloses a control method of an optical communication module, which includes a driving unit, an optical transmitting unit, a control unit and a signal transform control unit. The driving unit outputs a bias signal and a modulation signal in accordance with a bias control signal and a modulation control signal. The optical transmitting unit is electrically connected to the driving unit, outputs an optical signal in accordance with the bias signal and the modulation signal, and generates a feedback signal. The control unit is electrically connected to the optical transmitting unit, and controls the signal transform control unit to generate the bias control signal and the modulation signal, which are inputted into the driving unit in accordance with the feedback signal. The signal transform control unit includes a digital-to-analog converter, a current mirror and a comparator. The digital-to-analog converter generates a reference bias signal, a reference modulation signal and the modulation control signal in accordance with the digital bias signal and the digital modulation signal. The current mirror generates a modulator average photocurrent in accordance with the reference bias signal and the reference modulation signal. The comparator generates the bias control signal in accordance with the reference bias signal and the modulator average photocurrent. The control method includes a monitoring procedure and a feedback control procedure. The monitoring procedure is to monitor a feedback signal of the optical transmitting unit. The feedback control procedure is to decide whether to regulate the modulation signal or the modulator average photocurrent in accordance with a variation value of the feedback signal.

As mentioned above, the optical communication module and the control method thereof utilizes the control unit to control the signal transform control unit in accordance with the feedback signal so that the control unit outputs the relative signal for regulating the signal outputted from the driving unit. Accordingly, the optical communication module can regulate the driving parameter effectively and can save the regulating time of the conventional technique.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a conventional optical communication module;

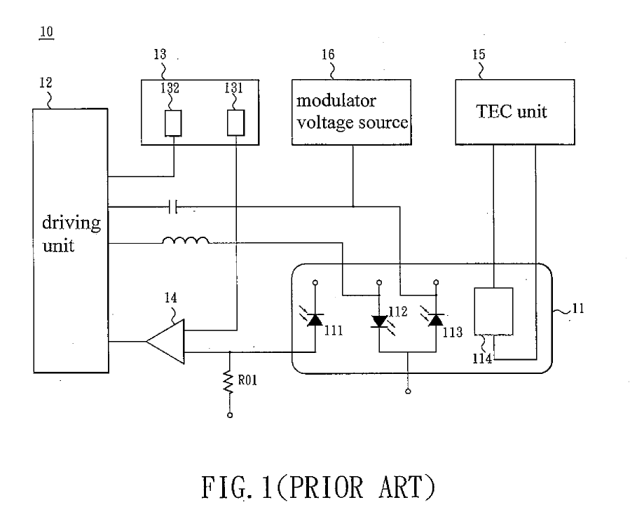

FIG. 2 is a schematic diagram showing an optical communication module according to an embodiment of the invention;

FIG. 3 is a flow chart showing a control method of the optical communication module according to the embodiment of the invention; and

FIG. 4 is a flow chart showing another control method of the optical communication module according to the embodiment of the invention.

### DETAILED DESCRIPTION OF THE INVENTION

The present invention will be apparent from the following detailed description, which proceeds with reference to the accompanying drawings, wherein the same references relate to the same elements.

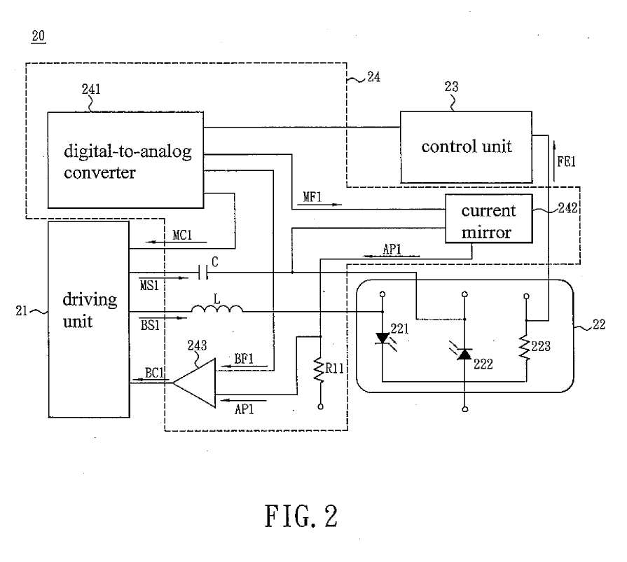

Referring to FIG. 2, an optical communication module 20 according to an embodiment of the invention includes a driving unit 21, an optical transmitting unit 22, a control unit 23 and a signal transform control unit 24. In the embodiment, the driving unit 21 is a laser diode driver, and the control unit 23 is a micro controller unit (MCU) or a central processing unit (CPU).

The driving unit 21 generates and outputs a bias signal BS1 and a modulation signal MS1 in accordance with a bias control signal BC1 and a modulation control signal MC1.

The optical transmitting unit 22 is electrically connected to the driving unit 21, and includes a laser diode 221, a modulation diode 222 and a thermistor 223. The optical transmitting unit 22 outputs an optical signal from the laser diode 221 in accordance with the bias signal BS1 and the modulation signal MS1, and generates a feedback signal FE1 by the thermistor 223. In the embodiment, the feedback signal FE1 is a temperature feedback signal.

The signal transform control unit 24 is electrically connected to the driving unit 21, and generates the bias control signal BC1 and the modulation control signal MC1 for controlling the driving unit 21.

The control unit 23 is electrically connected to the optical transmitting unit 22 and the signal transform control unit 24. The control unit 23 controls the signal transform control unit 24 to generate the bias control signal BC1 and the modulation control signal MC1. The control unit 23 calculates a relative value by a method of curve fitting for controlling the signal transform control unit 24 to generate the bias control signal BC1 and the modulation control signal MC1. The calculation method will be described below.

In the embodiment the signal transform control unit 24 includes a digital-to-analog converter 241, a current mirror 242 and a comparator 243. The digital-to-analog converter 241 is electrically connected to the control unit 23 through a serial peripheral interface (SPI) for transmitting data. The digital-to-analog converter 241 generates a reference bias signal BF1 and a reference modulation signal MF1, which are controlled by the control unit 23. The digital-to-analog converter 241 also generates the modulation control signal MC1. The current mirror 242 generates a modulator average photocurrent AP1 in accordance with the reference modulation signal MF1 and the modulation signal MS1, which is outputted by the driving unit 21. The comparator 243 generates the bias control signal BC1 in accordance with the reference bias signal BF1 and the modulator average photocurrent. The bias control signal BC1 controls the driving unit 21 to generate the bias signal BS1.

To be noted, the modulator average photocurrent AP1 generated by the current mirror 242 is a signal with current type. Therefore, it utilizes one end of a resistor R11 electrically connected to the current mirror 242 and the comparator 243 for transforming the modulator average photocurrent AP1 with the current type into the modulator average photocurrent AP1 with the voltage type. Accordingly, the comparator 243 generates the bias control signal BC1 in accordance with the modulator average photo current AP1 with the voltage type.

A control method of the optical communication module according to an embodiment of the invention will be described hereinbelow. In the embodiment, the configuration of the optical communication module is the same as the above-mentioned optical communication module 1. The control method of the optical communication module includes a monitoring procedure and a feedback control procedure. The monitoring procedure monitors a feedback signal of the optical transmitting unit 22. The feedback control procedure determines whether a modulation signal or a modulator average photocurrent outputted by the signal transform control unit is regulated or not in accordance with a variation of the feedback signal.

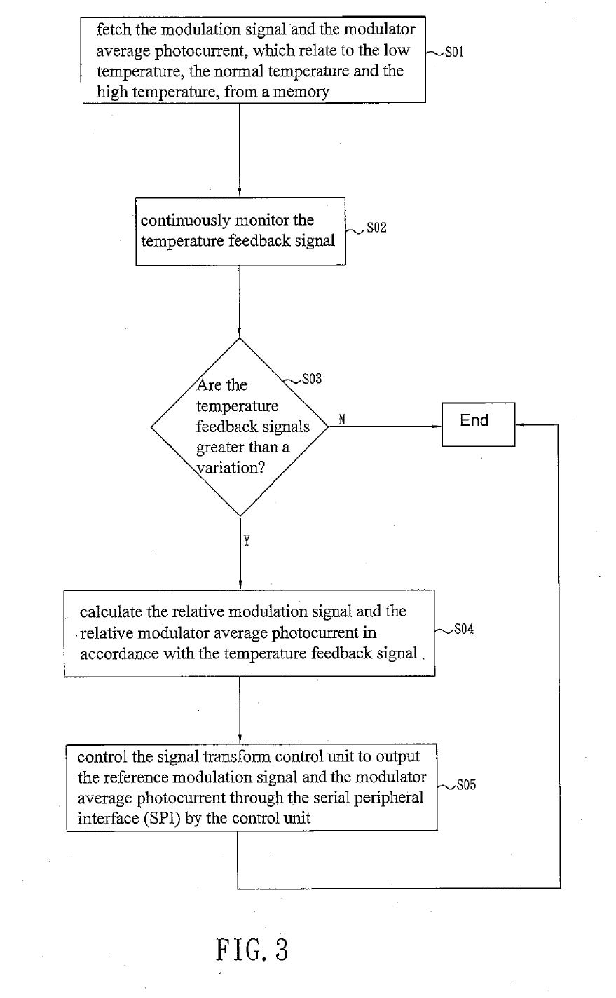

The control method of the optical communication module will be described with reference to FIG. 3 in view of FIG. 2. FIG. 3 is a flow chart showing a control method of the optical communication module according to the embodiment of the invention.

Referring to FIG. 3, the step S01 is to fetch the modulation signal MS1 and the modulator average photocurrent AP1, which relate to the low temperature, the normal temperature and the high temperature, from a memory. In the embodiment, the values of the modulation signal MS1 and the values of the modulator average photocurrent AP1 with respect to the low temperature, the normal temperature and the high temperature are attached in the operation manual or report of the optical transmitting unit 22. The values can be recorded in an EEPROM so that the control unit 23 can fetch the values any time. In addition, the values also can be recorded in the control unit 23.

The step S02 is to continuously monitor the temperature feedback signal FE1 generated by the thermistor 223. The step S03 is to determine whether the temperature feedback signals are greater than a variation or not. When the temperature feedback signals are smaller than the variation, the procedure is closed and the temperature feedback signals are continuously monitored. When the temperature feedback signals are greater than the variation, the step S04 is then performed.

The step S04 is to calculate the relative modulation signal MS1 and the relative modulator average photocurrent AP1 in accordance with the temperature feedback signal FE1. In the embodiment, the relative modulation signal MS1 and the relative modulator average photocurrent AP1 are obtained by the method of curve fitting as the following formula of:

Y=aX²+bX+c (formula I)

wherein a, b and c represent coefficients, Y represents the modulation signal MS1 or the modulator average photocurrent AP1, and X represents the temperature. Therefore, the relative modulation signal and the relative modulator average photocurrent in a fully range of the temperature can be calculated by the formula I according to the modulation signals and the modulator average photocurrents with the low temperature, the normal temperature and the high temperature.

The step S05 is to control the signal transform control unlit 24 to output the reference modulation signal MF1 and the modulator average photocurrent AP1 through the serial peripheral interface (SPI) by the control unit 23. Therefore, the optical output efficiency of the optical communication module 20 can be effectively controlled. After the step S05, the procedure is closed and the temperature feedback signal is continuously monitored.

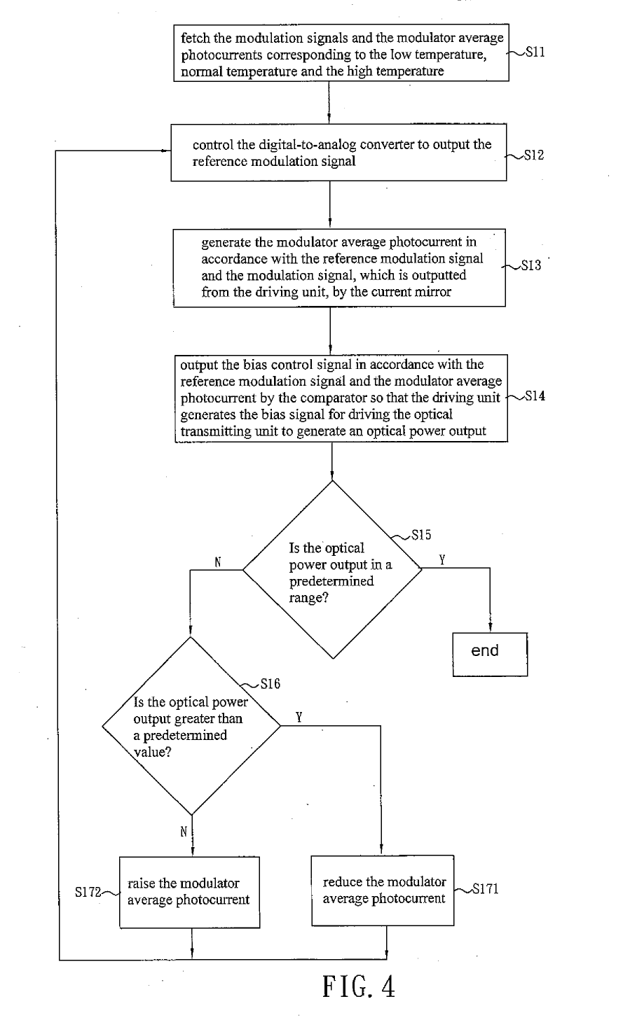

In addition, FIGS. 4 and 2 show another control method of the optical communication module according to the embodiment of the invention.

The step S11 is to fetch the modulation signals MS1 and the modulator average photocurrents AP1 corresponding to the low temperature, normal temperature and the high temperature.

The step S12 is to control the digital-to-analog converter 241 to output the reference modulation signal MF1.

The step S13 is to generate the modulator average photocurrent AP1 in accordance with the reference modulation signal MF1 and the modulation signal MS1 outputted from the driving unit 21 by the current mirror 242.

The step S14 is to output the bias control signal BC1 in accordance with the reference modulation signal BF1 and the modulator average photocurrent AP1 by the comparator 243 so that the driving unit 21 generates the bias signal BS1 for driving the optical transmitting unit 22 to generate an optical power output.

The step S15 is to determine whether the optical power output of the optical transmitting unit 22 is in a predetermined range or not. In the embodiment the control unit 23 determines whether the optical power output of the laser diode 221 in the optical transmitting unit 22 is in the predetermined range or not. When the optical power output is in the predetermined range, the procedure is closed. When the optical power output is not in the predetermined range, the step S16 is then performed.

The step S16 is to determine whether the optical power output is greater than a predetermined value or not. When the optical power output is greater than the predetermined value, the step S171 is then performed. When the optical power output is smaller than the predetermined value, the step S172 is then performed. The step S171 is to reduce the modulator average photocurrent AP1 for reducing the optical power output of the laser diode 221. The step S172 is to raise the modulator average photocurrent AP1 for raising the optical power output of the laser diode 221. The step S12 is then performed after the step S171 or the step S172.

To be noted, the step S171 and the step S172 can be performed by adding or subtracting a parameter for gradually regulating the output power of the laser diode 221.

In summary, the optical communication module and control method thereof utilizes the control unit to control the signal transform control unit in accordance with the feedback signal so that the control unit outputs the relative signal for regulating the signal outputted from the driving unit. Accordingly, the optical communication module can regulate the driving parameter effectively without the conventional digital resistor and can save the regulating time of the conventional technique.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical communication module comprising:
a driving unit outputting a bias signal and a modulation signal in accordance with a bias control signal and a modulation control signal;
an optical transmitting unit electrically connected to the driving unit, wherein the optical transmitting unit generates a feedback signal and outputs an optical signal in accordance with the bias signal and the modulation signal;
a signal transform control unit electrically connected to the driving unit for generating the bias control signal and the modulation control signal to be inputted to the driving unit; and
a control unit electrically connected to the optical transmitting unit and the signal transform control unit for controlling the signal transform control unit in accordance with the feedback signal.

2. The optical communication module according to claim 1, wherein the optical transmitting unit comprises a laser diode, a modulation diode and a thermistor, the laser diode generates the optical signal in accordance with the bias signal, the modulation diode modulates an optical power output of the optical signal in accordance with the modulation signal, and the thermistor generates the feedback signal.

3. The optical communication module according to claim 1, wherein the control unit is a micro controller unit (MCU) or a central processing unit (CPU).

4. The optical communication module according to claim 1, wherein the signal transform control unit comprises:
a digital-to-analog converter controlled by the control unit for generating a reference bias signal, a reference modulation signal and the modulation control signal;
a current mirror generating an modulator average photocurrent in accordance with the reference modulation signal and the modulation signal; and
a comparator generating the bias control signal in accordance with the reference bias signal and the modulator average photocurrent.

5. The optical communication module according to claim 4, wherein the signal transform control unit further comprises a resistor electrically connected to the current mirror and the comparator for transforming the modulator average photocurrent into a voltage type for the comparator to generate the bias control signal.

6. The optical communication module according to claim 4, wherein the control unit is electrically connected to the digital-to-analog converter by a serial peripheral interface (SPI).

7. The optical communication module according to claim 1, wherein the feedback signal is a temperature feedback signal.

8. The optical communication module according to claim 1, wherein the driving unit is a laser diode driver.

9. A control method of an optical communication module, wherein the optical communication module comprises a driving unit, an optical transmitting unit, a control unit and a signal transform control unit, the control method comprising:
a monitoring procedure for monitoring a feedback signal of the optical transmitting unit; and
a feedback control procedure for determining whether a modulation signal or a modulator average photocurrent outputted by the signal transform control unit is regulated in accordance with a variation of the feedback signal.

10. The control method according to claim 9, wherein the feedback control procedure further comprises a step of:
retrieving the modulation signal and the modulator average photocurrent from a memory, wherein the modulation signal and the modulator average photocurrent is relative to a low temperature, a normal temperature or a high temperature.

11. The control method according to claim 10, wherein when the variation of the feedback signal is larger than a threshold value, the feedback control procedure further comprises a step of:
calculating the modulation signal and the modulator average photocurrent according to the temperature feedback signal.

12. The control method according to claim 11, wherein the modulation signal is calculated by a method of curve fitting as a formula I:
Y=aX²+bX+c formula II
, wherein a, b and c represent coefficients, Y represents the modulation signal and X represents a temperature.

13. The control method according to claim 11, wherein the modulator average photocurrent is calculated by a method of curve fitting as a formula II:
Y=aX²+bX+c formula II
, wherein a, b and c represent coefficients, Y represents the modulator average photocurrent and X represents a temperature.

14. The control method according to claim 11, wherein the feedback control procedure further comprises a step of:
controlling the signal transform control unit by the control unit through a serial peripheral interface (SPI).

15. The control method according to claim 14, wherein the feedback control procedure further comprises a step of:
generating the modulator average photocurrent in accordance with a reference modulation signal generated by the signal transform control unit and the modulation signal generated by the driving unit.

16. The control method according to claim 14, wherein the feedback control procedure further comprises a step of:
generating a bias control signal in accordance with a reference modulation signal and the modulator average photocurrent generated by the signal transform control unit, wherein the driving unit generates a bias signal in accordance with the bias control signal for driving the optical transmitting unit to generate an optical power output.

17. The control method according to claim 9, wherein the feedback signal comprises an optical power output of the optical transmitting unit.

18. The control method according to claim 17, wherein the feedback control procedure further comprises a step of:
determining whether the optical power output is within a predetermined range or not.

19. The control method according to claim 18, wherein when the optical power output is not within the predetermined range, the feedback control procedure further comprises a step of determining whether the optical power output is greater than a predetermined value or not.

20. The control method according to claim 19, wherein when the optical power output is greater than the predetermined value, the feedback control procedure further comprises a step of increasing the modulator average photocurrent, and when the optical power output is smaller than the predetermined value, the feedback control procedure further comprises a step of decreasing the modulator average photocurrent.

21. The control method according to claim 20, wherein the modulator average photocurrent is increased or decreased by way of adding or subtracting a parameter for gradually regulating the optical power output.
